(19) United States
(12) Patent Application Publication
(10) Pub. No.: US 2017/0068629 A1
(43) Pub. Date: Mar. 9, 2017

(54) SEMICONDUCTOR APPARATUS AND STATUS CONTROL METHOD OF SEMICONDUCTOR APPARATUS

(71) Applicant: Renesas Electronics Corporation, Tokyo (JP)

(72) Inventor: Hideaki TOMONAGA, Tokyo (JP)

(21) Appl. No.: 15/208,262

(22) Filed: Jul. 12, 2016

(30) Foreign Application Priority Data
Sep. 9, 2015 (JP) 2015-177407

(51) Int. Cl. G06F 13/40; G06F 13/364; G06F 1/32

(52) U.S. Cl. CPC G06F 13/4022; G06F 1/3287; G06F 13/364

(57) ABSTRACT

A semiconductor apparatus according to the present invention operates in one of a first status in which a generated event is processed and a plurality of second statuses in which the event is not processed. The semiconductor apparatus includes a control circuit that controls a status of the semiconductor apparatus and outputs a status signal that indicates the status of the semiconductor apparatus, a switching time storage circuit that stores, for each of the plurality of second statuses, a switching time required to switch the status of the semiconductor apparatus from the second status to the first status so that the event can be processed, and a notification circuit that selects a switching time corresponding to one of the plurality of second statuses indicated by the status signal output from the control circuit and outputs a notification signal for previously notifying the control circuit of generation of an event when a time, which is obtained by adding the selected switching time to a current time, reaches a time when the event is generated. The control circuit switches the status of the semiconductor apparatus from the second status to the first status in response to the notification signal from the notification circuit.

### CROSS-REFERENCE TO RELATED APPLICATIONS

This application is based upon and claims the benefit of priority from Japanese patent application No. 2015-177407, filed on Sep. 9, 2015, the disclosure of which is incorporated herein in its entirety by reference.

### BACKGROUND

The present invention relates to a semiconductor apparatus and a status control method of the semiconductor apparatus, and to, for example, a semiconductor apparatus that operates in one of a plurality of statuses.

There may be a system that is configured in such a way that a slave performs control in response to information transmitted periodically or at a scheduled time from a master (e.g., Published Japanese Translation of PCT International Publication for Patent Application, No. 2009-545048). In particular, in industrial network equipment, quick responsiveness is desired for a slave such that the slave analyzes information as quickly as possible after it receives the information from a master and performs control according to a result of the analysis. In other words, the slave is desired to quickly process an event upon generation of the event.

On the other hand, it is desired to reduce power consumption and improve power efficiency of such industrial network equipment as much as possible. The power consumption can be reduced by switching the slave to a power-saving mode after the slave completes the process in response to the information from the master. However, the present inventor has found a problem that when the slave is switched to the power-saving mode, it takes time for the slave to return from the power-saving mode in response to information from the master and then enter a status in which the information can be processed, thereby losing quick responsiveness of the slave. The present inventor has found another problem that when a frequency of a Central Processing Unit (CPU) of the slave is simply increased in order to shorten the time for the slave to return from the power-saving mode, the power consumption is increased, and the power efficiency is reduced.

### SUMMARY

As mentioned above, quick responsiveness in which a generated event should be processed at once is desired.

Other problems of the related art and new features of the present invention will become apparent from the following descriptions of the specification and attached drawings.

In an aspect of the present invention, a semiconductor apparatus includes: a control circuit configured to control a status of the semiconductor apparatus; and a notification circuit configured to, when the status of the semiconductor apparatus is a second status, select a switching time corresponding to the second status indicated by a status signal output from the control circuit and output, to the control circuit, a notification signal for previously notifying the control circuit of generation of an event when a time, which is obtained by adding the selected switching time to a current time, reaches a time when the event is generated.

According to the above aspect, quick responsiveness can be improved.

### BRIEF DESCRIPTION OF THE DRAWINGS

The above and other aspects, advantages and features will be more apparent from the following description of certain embodiments taken in conjunction with the accompanying drawings, in which:

FIG. 1 is a drawing showing a configuration of an industrial network system according to a first embodiment;

FIG. 2 is a drawing showing a configuration of an LSI according to the first embodiment;

FIG. 3 is a drawing showing a configuration of an advance notification generating circuit according to the first embodiment;

FIG. 4 is a timing chart showing a first operation example of the LSI according to the first embodiment;

FIG. 5 is a timing chart showing a second operation example of the LSI according to the first embodiment;

FIG. 6 is a timing chart showing a third operation example of the LSI according to the first embodiment;

FIG. 7 is a drawing showing a configuration of an LSI according to a second embodiment;

FIG. 8 is a drawing showing a configuration of an advance notification generating circuit according to the second embodiment; and

FIG. 9 is a drawing showing a schematic configuration of an LSI according to an embodiment.

### DETAILED DESCRIPTION

Hereinafter, preferable embodiments will be described with reference to the drawings. Specific numerical values shown in the following embodiments are merely examples for easier understanding of the embodiments, and the present invention is not limited to them unless otherwise particularly specified. In the following descriptions and the drawings, matters obvious to those skilled in the art have been omitted or simplified as appropriate in order to clarify the descriptions.

### First Embodiment

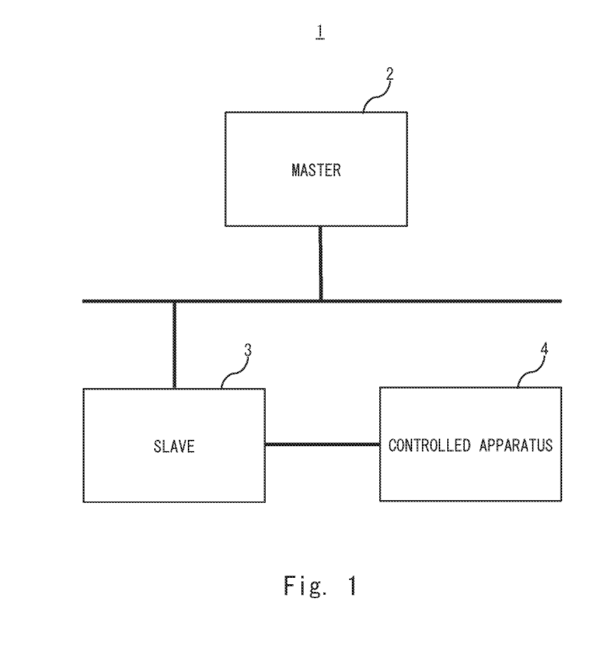

Firstly, a configuration of an industrial network system 1 according to a first embodiment will be described with reference to FIG. 1. As shown in FIG. 1, the industrial network system 1 includes a master 2, a slave 3, and a controlled apparatus 4.

The master 2 and the slave 3 are connected to each other via a predetermined network. Any standard may be employed as the standard for the network. For example, Ethernet (registered trademark) may be employed as the standard of the network. The slave 3 and the controlled apparatus 4 are connected to each other via a predetermined network. Any motion network standard may be employed as the standard for the network.

The master 2 is a control apparatus that controls the slave 3. The master 2 is, for example, a Programmable Logic Controller (PLC). The master 2 generates events. To be more specific, the master 2 transmits instruction information that instructs execution of a process at a predetermined time or periodically at a predetermined time interval to the slave 3.

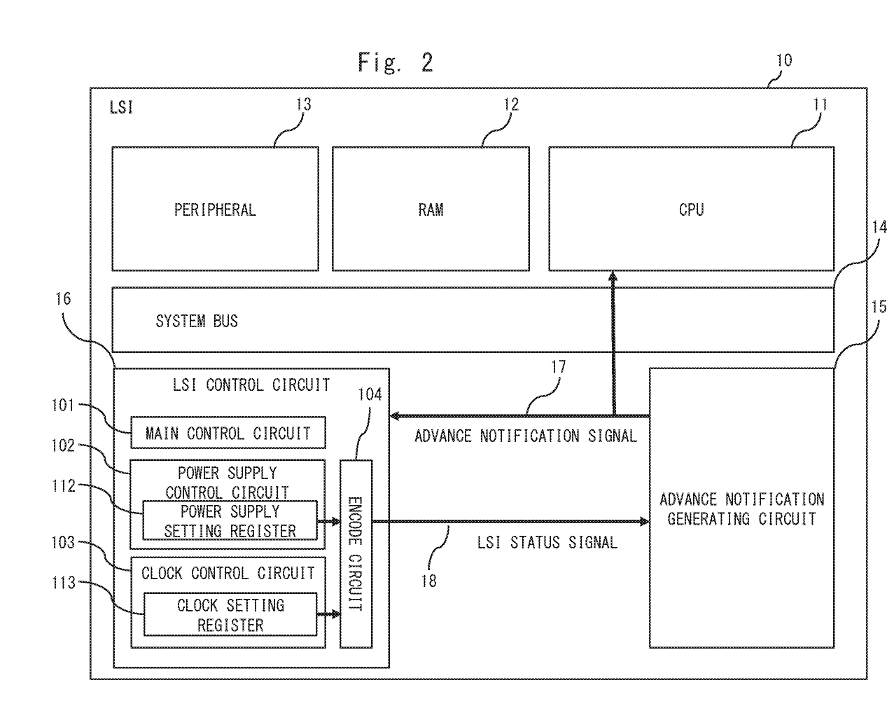

The slave 3 is a control apparatus that controls the controlled apparatus 4. The slave 3 is, for example, a servo controller. The slave 3 processes generated events. More specifically, the slave 3 executes the process according to the instruction information received from the master 2. The slave 3 includes a Large Scale Integration (LSI) 10, which will be described later with reference to FIG. 2, that executes the process.

The slave 3 can execute at least one of the following processes as the process to be executed in response to generation of an event. That is, the instruction information is information instructing the slave 3 to execute, for example, one of the following processes (1) to (3).

(1) Transmitting information indicating a status of the slave 3 to the master 2
(2) Changing a control parameter of the slave 3 to control the controlled apparatus 4
(3) Controlling the controlled apparatus 4

As described above, a phenomenon that causes the slave 3 to execute a process, such as the above reception of the instruction information transmitted from the master 2 by the slave 3, is referred to as an event. Although an example in which the event is the reception of the instruction information from the master 2 will be described below, other phenomena may be treated as events as long as they are phenomena that cause the slave 3 to execute processes. For example, when the slave 3 regularly executes a process (e.g., control on the controlled apparatus 4) regardless of whether or not the slave 3 has received the instruction information from the master 2, the event may be set to when a current time reaches a time for executing the process. In this case, for example, a timer interrupt that is generated periodically at a predetermined time interval in a timer (not shown) included in the LSI 10 may be used as generation of the event.

The controlled apparatus 4 operates according to the control by the slave 3. If the industrial network system 1 is, for example, a production system, the controlled apparatus 4 includes a motor that is included in a robot for assembling a product. In such a case, the slave 3 controls the motor of the robot.

Although FIG. 1 shows an example in which there is one each of the slave 3 and the controlled apparatus 4, it is not limited to this. The industrial network system 1 may include a plurality of slaves 3 and a plurality of controlled apparatuses 4. Further, the number of the slaves 3 may not be necessarily the same as that of the controlled apparatuses 4. For example, one slave 3 may control a plurality of the controlled apparatuses 4.

Next, a configuration of the LSI 10 included in the slave 3 according to the first embodiment will be described with reference to FIG. 2. As shown in FIG. 2, the LSI 10 includes a CPU 11, a Random Access Memory (RAM) 12, a peripheral 13, a system bus 14, an advance notification generating circuit 15, and an LSI control circuit 16.

The CPU 11 is an arithmetic processing circuit that executes the above process in cooperation with other circuits 12 to 16 inside the LSI 10. That is, the CPU 11 executes the process in response to generation of the event. The CPU 11 executes the above process by, for example, executing a program including instructions for causing the CPU 11 to execute the above process.

The RAM 12 is a storage circuit that stores information for the CPU 11 to execute the above process. Specifically, the information stored in the RAM 12 includes, for example, the above program.

The peripheral 13 is a peripheral circuit that executes dedicated processes on behalf of the CPU 11. The LSI 10 may include, for example, a circuit that exclusively executes control on the controlled apparatus 4 (e.g., motor control) as the peripheral 13. In this case, the CPU 11 instructs the peripheral 13 to control the controlled apparatus 4. Then, the peripheral 13 may execute the control on the controlled apparatus 4 on behalf of the CPU 11 in response to the instruction from the CPU 11. For example, the peripheral 13 executes a process that performs Direct Memory Access (DMA) transfer on the information for controlling the controlled apparatus 4 that has been stored by the CPU 11 in the RAM 12 from the RAM 12 to the controlled apparatus 4.

The system bus 14 connects the respective circuits 11 to 13, 15, and 16 inside the LSI 10 to each other. The respective circuits 11 to 13, 15, and 16 inside the LSI 10 input and output various information (various signals) with each other through the system bus 14. For example, each of the CPU 11 and the peripheral 13 obtains information stored in the RAM 12 through the system bus 14. For example, the CPU 11 outputs a signal indicating the above instruction to the peripheral 13 through the system bus 14.

The advance notification generating circuit 15 outputs an advance notification signal 17 that previously notifies the CPU 11 and the LSI control circuit 16 that an event will be generated to the CPU 11 and the LSI control circuit 16. That is, the advance notification signal 17 is output at a predetermined amount of time before a time when an event is generated. Note that the advance notification generating circuit 15 selects, as the above predetermined time, a time according to the current status of the LSI 10 indicated by an LSI status signal 18, which will be described later.

The LSI control circuit 16 controls the status of the LSI 10. Further, the LSI control circuit 16 outputs the LSI status signal 18 indicating the current status of the LSI 10 to the advance notification generating circuit 15. The LSI control circuit 16 includes a main control circuit 101, a power supply control circuit 102, a clock control circuit 103, and an encode circuit 104. The power supply control circuit 102 includes a power supply setting register 112. The clock control circuit 103 includes a clock setting register 113.

The main control circuit 101 controls the status of the LSI 10. One of conditions for the main control circuit 101 to evaluate as to whether or not to switch the status of the LSI 10 is the advance notification signal 17. The main control circuit 101 evaluates as to whether or not to switch the status of the LSI 10 based on the advance notification signal 17 output from the advance notification generating circuit 15. When the main control circuit 101 determines not to switch the status of the LSI 10, the current status is maintained. When the main control circuit 101 determines to switch the status of the LSI 10, the status of the LSI 10 is switched.

In order to switch the status of the LSI 10, the main control circuit 101 controls the power supply control circuit 102 and the clock control circuit 103 so that a power supply status and a clock supply status of the LSI 10 will be those according to the switched status of the LSI 10. To be more specific, the main control circuit 101 sets a power supply setting value indicating the power supply status according to the switched status to the power supply setting register 112. Determination on whether to supply or stop power to an arbitrary circuit inside the LSI 10 and at least one of voltage values supplied to an arbitrary circuit inside the LSI 10 may be set as the power supply status. Further, the main control circuit 101 sets a clock setting value indicating the clock supply status according to the switched status to the clock setting register 113. Determination on whether to supply or stop clock signals to an arbitrary circuit inside the LSI 10 and at least one of frequencies of clock signals supplied to the arbitrary circuit inside the LSI 10 may be set as the clock supply status.

The power supply control circuit 102 controls the power supply status of the LSI 10 so that the LSI 10 will be in the power supply status indicated by the power supply setting value set to the power supply setting register 112. The clock control circuit 103 controls the clock supply status of the LSI 10 so that LSI 10 will be in the clock supply status indicated by the clock setting value set to the clock setting register 113.

The encode circuit 104 encodes the power supply setting value set to the power supply setting register 112 and the clock setting value set to the clock setting register 113 to generate the LSI status signal 18 indicating the current status of the LSI 10. For example, the encode circuit 104 generates the LSI status signal 18 indicating the status of the LSI 10 with the number of bits smaller than the total number of bits of the power supply setting value and the clock setting value. The encode circuit 104 outputs the generated LSI status signal 18 to the advance notification generating circuit 15.

As described above, the LSI status signal 18 is not limited to a value that is obtained by encoding the power supply setting value and the clock setting value. For example, the LSI control circuit 16 may output the unprocessed power supply setting value and clock setting value to the advance notification generating circuit 15 as the LSI status signal 18. However, preferably, as described above, the power supply setting value and the clock setting value may be encoded, and then a value simply indicating the current status of the LSI 10 may be notified to the advance notification generating circuit 15, thereby eliminating the need for the advance notification generating circuit 15 to derive the current status of the LSI 10 from a combination of the power supply setting value and the clock setting value. By doing so, it is also possible to reduce the number of signal lines for transmitting the LSI status signal 18.

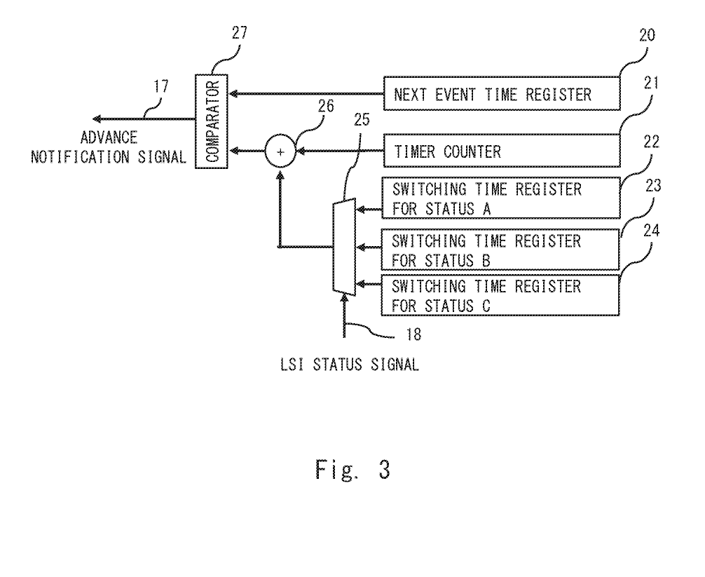

Next, a configuration of the advance notification generating circuit 15 according to the first embodiment will be described with reference to FIG. 3. As shown in FIG. 3, the advance notification generating circuit 15 includes a next event time register 20, a timer counter 21, a switching time register for status A 22, a switching time register for status B 23, a switching time register for status C 24, a multiplexer 25, an adder 26, and a comparator 27.

The next event time register 20 is a storage circuit in which the CPU 11 stores a value indicating a time when a next event will be generated. The next event time register 20 outputs the value stored therein to the comparator 27.

The timer counter 21 is a circuit that counts a current time. The timer counter 21 outputs a value indicating the current time to the comparator 27.

Each of the switching time register for status A 22, the switching time register for status B 23, and the switching time register for status C 24 stores a value indicating the above predetermined time. The switching time register for status A 22, the switching time register for status B 23, and the switching time register for status C 24 correspond to statuses A, B, and C, respectively, which the LSI 10 can enter. In other words, the number of the switching time register for status A 22, the switching time register for status B 23, and the switching time register for status C 24 is the same as the number of the statuses which the LSI 10 can enter. That is, in the first embodiment, an example in which the number of statuses which the LSI 10 can enter is three, namely, the statuses A, B, and C, will be described. However, the number of statuses which the LSI 10 can enter is not limited to this. The number of statuses which the LSI 10 can enter may be two or four or greater. In this case, the number of switching time registers is the same as the number of the statuses for the LSI 10.

As an example, the status A is a normal status, the status B is a first power-saving status in which an amount of power consumed is lower than that in the status A, and the status C is a second power-saving status in which an amount of power consumed is lower than that in the status B. For example, any one of the following statuses (1) to (4) or a combination of any two of the following statuses (1) to (4) may be considered as being the power-saving mode.

(1) Supply of clock signals to an arbitrary circuit block inside the LSI 10 is stopped
(2) Supply of power to an arbitrary circuit block inside the LSI 10 is stopped
(3) A voltage supplied to an arbitrary circuit inside the LSI 10 is reduced
(4) Frequencies of clock signals supplied to an arbitrary circuit block inside the LSI 10 are reduced

For example, a status of (1) in which supply of clock signals to the CPU 11 is stopped may be the status B, and a status of (1)+(2) in which supply of clock signals to the CPU 11 is stopped and, in addition, supply of power to the CPU 11 is stopped may be the status C. Alternatively, for example, a status of (3)+(4) in which a voltage supplied to the CPU 11 is reduced and, in addition, frequencies of clock signals supplied to the CPU 11 are reduced may be the status B, and a status of (1)+(2) in which supply of clock signals to the CPU 11 is stopped and, in addition, supply of power to the CPU 11 is stopped may be the status C. For example, when a sleep time of the CPU 11 reaches a first predetermined time, the LSI control circuit 16 switches the status of the LSI 10 to the status of (3)+(4), namely, the status B. When a sleep time of the CPU 11 reaches a second predetermined time which is longer than the first predetermined time, the LSI control circuit 16 switches the status of the LSI 10 to the status of (1)+(2), namely, the status C. While the CPU 11 is in a sleep mode, the above control on the controlled apparatus 4 may be performed by the peripheral 13. Note that it is obvious that arbitrary statuses other than the above statuses may be employed as the statuses B and C (the power-saving statuses).

Further, the status A (the normal status) includes a status in which a process of an event is executed (a status in which an event can be processed) and a status in which a process other than the event is executed (a status in which the event cannot be processed).

That is, the status of the LSI 10 includes a first status in which a generated event is processed and a second status in which the generated event is not processed (or the generated event cannot be processed). The first status is a status in which a process of an event is executed in the normal status (a status in which an event can be processed). The second status includes a status in which a process other than the event is executed in the normal status (a status in which the event cannot be processed) and a plurality of power-saving statuses.

The switching time register for status A 22 is a storage circuit that stores a value indicating a switching time required for the CPU 11 to switch the status of the CPU 11 (the LSI 10) from the status in which the process other than the event is executed to the status in which the event can be executed. The switching time is previously determined in consideration of variation in clocks that drive the timer counter 21 between the master 2 and the slave 3, and a time taken to prepare an event process after the status is switched to the status in which the process of the event is executed.

The switching time register for status B 23 is a storage circuit that stores a value indicating a switching time required for the LSI control circuit 16 to switch the status of the LSI 10 from the status B to the status A so that an event can be processed. The switching time is previously determined in consideration of variation in times required to switch the status from the status B to the status A, variation in clocks that drive the timer counter 21 between the master 2 and the slave 3, and a time taken to prepare an event process after the status is switched to the status A.

The switching time register for status C 24 is a storage circuit that stores a value indicating a switching time required for the LSI control circuit 16 to switch the status of the LSI 10 from the status C to the status A so that the event can be processed. The switching time is previously determined in consideration of variation in times required to switch the status from the status C to the status A, variation in clocks that drive the timer counter 21 between the master 2 and the slave 3, and a time taken to prepare an event process after the status is switched to the status A.

The multiplexer 25 selects a value output from one of the switching time register for status A 22, the switching time register for status B 23, and the switching time register for status C 24 that corresponds to the status of the LSI 10 indicated by the LSI status signal 18 output from the LSI control circuit 16 and then outputs the selected value to the adder 26. That is, when the status of the LSI 10 indicated by the LSI status signal 18 is the status A, the multiplexer 25 selects a value output from the switching time register for status A 22 and then outputs the selected value to the adder 26. When the status of the LSI 10 indicated by the LSI status signal 18 is the status B, the multiplexer 25 selects a value output from the switching time register for status B 23 and then outputs the selected value to the adder 26. When the status of the LSI 10 indicated by the LSI status signal 18 is the status C, the multiplexer 25 selects a value output from the switching time register for status C 24 and then outputs the selected value to the adder 26.

The adder 26 adds the switching time indicated by the value output from the multiplexer 25 to the current time indicated by the value output from the timer counter 21 and then outputs a value indicating the added time to the comparator 27.

The comparator 27 compares the time indicated by the value output from the next event time register 20 with the time indicated by the value output from the adder 26. When the time indicated by the value output from the adder 26 is a time at or after the time indicated by the value output from the next event time register 20, the comparator 27 asserts the advance notification signal 17 that is output to the CPU 11 and the LSI control circuit 16. Whereas when the time indicated by the value output from the adder 26 is a time before the time indicated by the value output from the next event time register 20, the comparator 27 will not assert the advance notification signal 17 and continues to negate the advance notification signal 17 that is output to the CPU 11 and the LSI control circuit 16.

That is, with such a configuration, while the LSI 10 is in the status A, when a time, which is obtained by adding a switching time required to switch the status of the LSI 10 from the status in which the process other than the event is executed to the status in which a process of the event is executed so that the event can be executed to the current time, reaches a time when the event is generated, the advance notification signal 17 is asserted.

While the LSI 10 is in the status B or C, when a time, which is obtained by adding a switching time required to switch the status of the LSI 10 from the status B or C to the status A so that the event can be executed to the current time, reaches a time when the event is generated, the advance notification signal 17 is asserted.

In the first embodiment, with such a configuration, it is possible to return the status of the LSI 10 to the status before an event is processed by the time when the event is generated even when the LSI 10 is in the status in which an event is not processed.

Hereinafter, an operation of the LSI 10 according to the first embodiment will be described. Note that in the following descriptions, an example in which “2” is set to the switching time register for status A 22, “4” is set to the switching time register for status B 23, and “6” is set to the switching time register for status C 24 will be described.

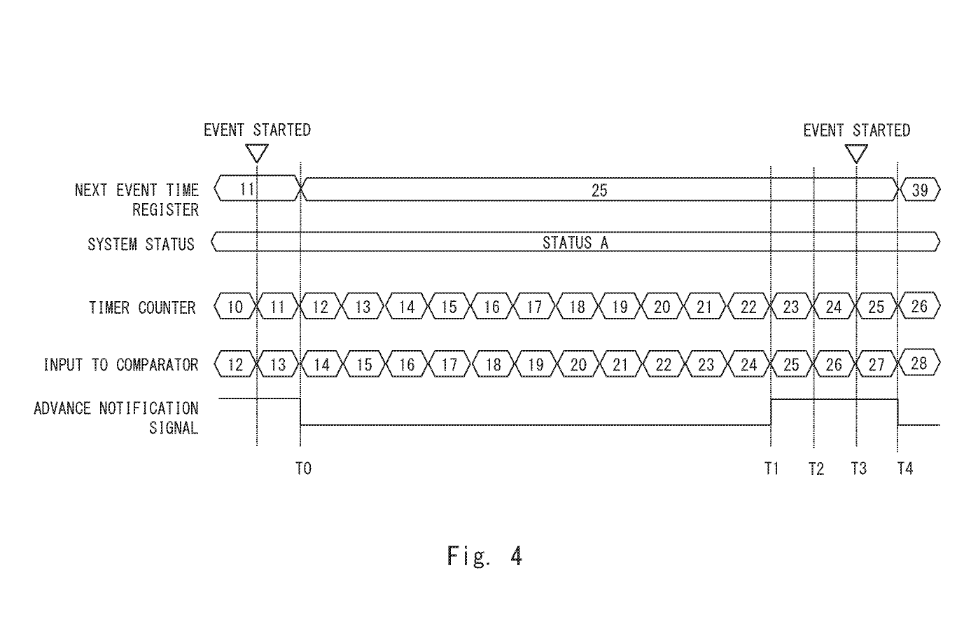

Firstly, an operation for previously sending a notification of generation of an event when the status of the LSI 10 is the status A will be described with reference to FIG. 4. In this example, to begin with, at a time “11”, a generated event is processed, and the advance notification signal 17 is asserted.

### T0:

The CPU 11 sets “25” to the next event time register 20. For example, when it is previously known that a cycle in which an event is generated is a cycle every time a time “14” passes, the CPU 11 stores a value indicating a time “25”, which is obtained by adding a predetermined time “14” to a timer counter value “11” as of the time when the event is generated, in the next event time register 20. Then, a time (a value output from the adder 26 and input to the comparator 27) obtained by adding a value “12” output from the timer counter 21 to a value “2” output from the multiplexer 25 will become “14”, which is a time before the time “25” indicated by the value output from the next event time register 20. Thus, the comparator 27 negates the advance notification signal 17 that is output to the CPU 11 and the LSI control circuit 16.

### T1:

A time (a value output from the adder 26 and input to the comparator 27) obtained by adding a value “23” output from the timer counter 21 to the value “2” output from the multiplexer 25 will become “25”, which is at or after the time “25” indicated by the value output from the next event time register 20. Thus, the comparator 27 asserts the advance notification signal 17 that is output to the CPU 11 and the LSI control circuit 16. In response to the assertion of the advance notification signal 17 output from the comparator 27, the CPU 11 starts switching the status in which a process other than an event is executed to the status in which a process of the event is executed. That is, the CPU 11 executes a process to end the process other than the event.

### T2:

The switching of the status from the status in which the process other than the event is executed to the status in which the process of the event is executed is completed, and then the CPU 11 prepares to process the event. For example, the CPU 11 performs an arbitrary process in order for the LSI 10 to enter a status in which an event can be immediately processed when the event is generated.

### T3:

An event is generated. The CPU 11 executes a process for the generated event.

### T4:

The CPU 11 sets “39” to the next event time register 20. For example, when it is previously known that a cycle in which an event is generated is a cycle every time a time “14” passes, the CPU 11 stores a value indicating a time “39”, which is obtained by adding a predetermined time “14” to a timer counter value “25” as of the time when the event is generated, in the next event time register 20. Then, a time (a value output from the adder 26 and input to the comparator 27) obtained by adding a value “26” output from the timer counter 21 to a value “2” output from the multiplexer 25 will become “28”, which is a time before the time “39” indicated by the value output from the next event time register 20. Thus, the comparator 27 negates the advance notification signal 17 that is output to the CPU 11 and the LSI control circuit 16.

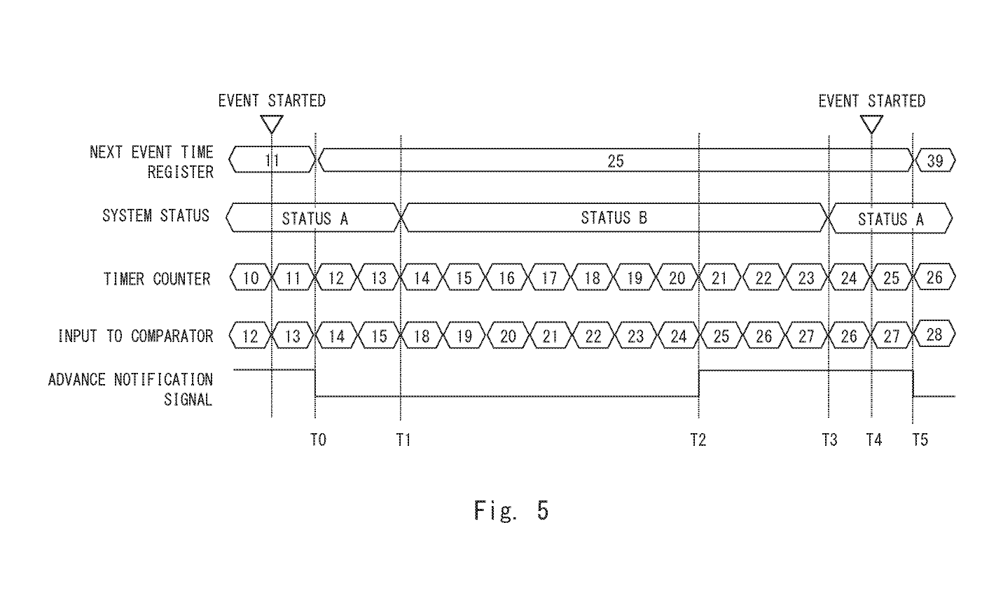

Firstly, an operation for previously sending a notification of generation of an event when the status of the LSI 10 is the status B will be described with reference to FIG. 5. In this example, to begin with, at a time “11”, a generated event is processed, and the advance notification signal 17 is asserted.

### T0:

The CPU 11 sets “25” to the next event time register 20. Note that a method for calculating a value to be stored in the next event time register 20 is the same as the one described above. The comparator 27 negates the advance notification signal 17 that is output to the CPU 11 and the LSI control circuit 16 for the same reason described above.

### T1:

The LSI control circuit 16 switches the status of the LSI 10 to the status B and also outputs the LSI status signal 18 indicating the status B to the advance notification generating circuit 15. Then, the multiplexer 25 of the advance notification generating circuit 15 selects a value output from the switching time register for status B 23 and then outputs the selected value to the adder 26.

### T2:

A time (a value output from the adder 26 and input to the comparator 27) obtained by adding a value “21” output from the timer counter 21 to a value “4” output from the multiplexer 25 will become “25”, which is at or after the time “25” indicated by the value output from the next event time register 20. Thus, the comparator 27 asserts the advance notification signal 17 that is output to the CPU 11 and the LSI control circuit 16. In response to the assertion of the advance notification signal 17 output from the comparator 27, the LSI control circuit 16 starts switching the status from the status B to the status A.

### T3:

The switching of the status from the status B to the status A is completed, and then the CPU 11 prepares to process the event. For example, the CPU 11 performs an arbitrary process in order for the LSI 10 to enter a status in which an event can be immediately processed when the event is generated.

### T4:

An event is generated. The CPU 11 executes a process for the generated event.

### T5:

The CPU 11 sets “39” to the next event time register 20. Note that a method for calculating a value to be stored in the next event time register 20 is the same as the one described above. The comparator 27 negates the advance notification signal 17 that is output to the CPU 11 and the LSI control circuit 16 for the same reason described above.

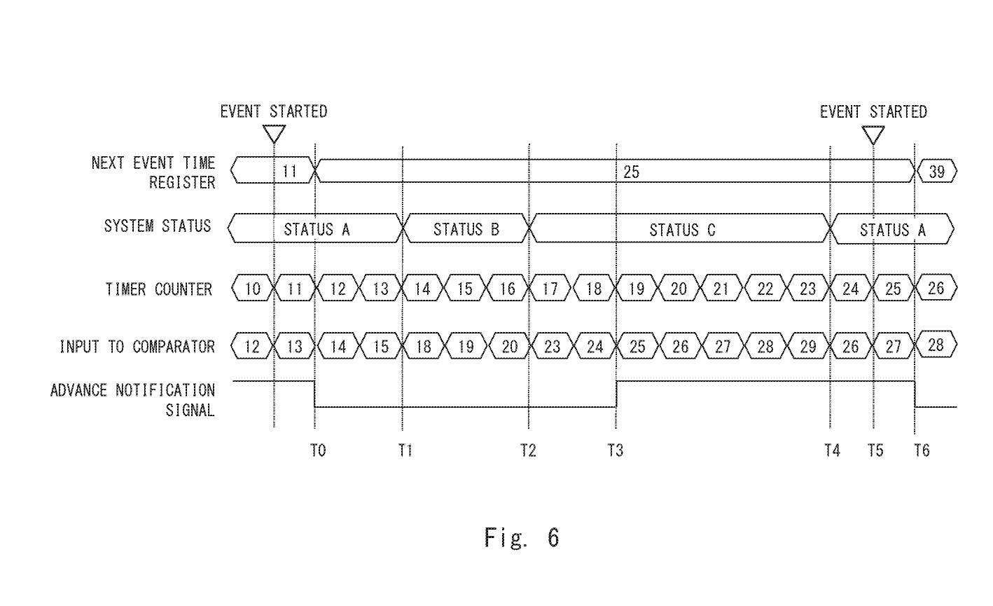

Firstly, an operation for previously sending a notification of generation of an event after the status of the LSI 10 is switched from the status B to the status C will be described with reference to FIG. 6. In this example, to begin with, at a time “11”, a generated event is processed, and the advance notification signal 17 is asserted.

### T0:

The CPU 11 sets “25” to the next event time register 20. Note that a method for calculating a value to be stored in the next event time register 20 is the same as the one described above. The comparator 27 negates the advance notification signal 17 that is output to the CPU 11 and the LSI control circuit 16 for the same reason described above.

### T1:

The LSI control circuit 16 switches the status of the LSI 10 to the status B and also outputs the LSI status signal 18 indicating the status B to the advance notification generating circuit 15. Then, the multiplexer 25 of the advance notification generating circuit 15 selects a value output from the switching time register for status B 23 and then outputs the selected value to the adder 26.

### T2:

The LSI control circuit 16 switches the status of the LSI 10 to the status C and also outputs the LSI status signal 18 indicating the status C to the advance notification generating circuit 15. Then, the multiplexer 25 of the advance notification generating circuit 15 selects a value output from the switching time register for status C 24 and then outputs the selected value to the adder 26.

### T3:

A time (a value output from the adder 26 and input to the comparator 27) obtained by adding a value “19” output from the timer counter 21 to a value “6” output from the multiplexer 25 will become “25”, which is at or after the time “25” indicated by the value output from the next event time register 20. Thus, the comparator 27 asserts the advance notification signal 17 that is output to the CPU 11 and the LSI control circuit 16. In response to the assertion of the advance notification signal 17 output from the comparator 27, the LSI control circuit 16 starts switching the status from the status C to the status A.

### T4:

The switching of the status from the status C to the status A is completed, and then the CPU 11 prepares to process the event. For example, the CPU 11 performs an arbitrary process in order for the LSI 10 to enter a status in which an event can be immediately processed when the event is generated.

### T5:

An event is generated. The CPU 11 executes a process for the generated event.

### T6:

The CPU 11 sets “39” to the next event time register 20. Note that a method for calculating a value to be stored in the next event time register 20 is the same as the one described above. The comparator 27 negates the advance notification signal 17 that is output to the CPU 11 and the LSI control circuit 16 for the same reason described above.

As described above, with the processes for the LSI 10 according to the first embodiment, it is possible to return the status of the LSI 10 to the status in which a process for an event can be executed so that the event can be processed immediately when the event is generated even when the LSI 10 is switched to the status in which an event is not processed.

In a system that performs various processes, the status of the LSI may be in the status in which an event cannot be processed because of software or hardware control. However, if the notification is transmitted at a time when an event is generated, it may be necessary to switch the status of the LSI at that point. This will delay execution of a process for the event. On the other hand, when the advance notification for the event is transmitted too early for the time when the event is generated, there will be a free time before the event is generated, thereby possibly disturbing the power-saving status or execution of other processes, and thus reducing the processing efficiency.

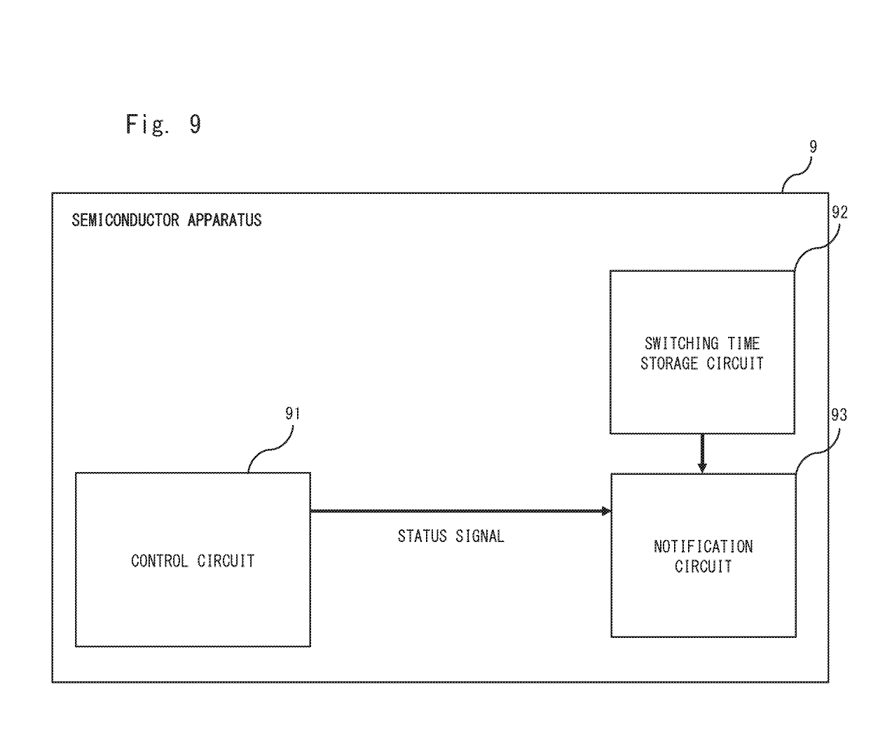

On the other hand, as shown in a schematic diagram of FIG. 9, a semiconductor apparatus 9 (corresponding to the LSI 10) according to the first embodiment operates in one of the first status in which a generated event is processed (corresponding to the status in which a process of an event is executed in the normal status) and a plurality of the second statuses in which the event is not processed (corresponding to the statuses in which the process of the event is not executed in the normal status, and the power-saving status).

The semiconductor apparatus 9 includes a control circuit 91 (corresponding to the LSI control circuit 16 and the CPU 11), a switching time storage circuit 92 (corresponding to the switching time register for status A 22, the switching time register for status B 23, and the switching time register for status C 24), and a notification circuit 93 (corresponding to other circuits 20, 21, and 25 to 27 in the advance notification generating circuit 15).

The control circuit 91 controls a status of the semiconductor apparatus 9 and also outputs a status signal indicating the status of the semiconductor apparatus 9. The switching time storage circuit 92 stores, for each of the plurality of second statuses, a switching time required to switch the status from the second state to the first state so that an event can be processed. When the status of the semiconductor apparatus 9 is the second status, the notification circuit 93 selects, from the switching times stored in the switching time storage circuit 92, the switching time corresponding to the second status indicated by the status signal output from the control circuit 91 and then outputs a notification signal that previously notifying the control signal 91 of generation of an event to the control circuit 91 at a time when the event is generated.

Accordingly, it is possible to ensure an appropriate status switching time and to complete preparation for an event process by a time when the event is generated by generating the advance notification signal according to the status of the LSI. Consequently, it is possible to optimize the control on the status of the LSI and to quickly start the event process. Further, switching of the status of the LSI can be completed before the event is generated by ensuring the switching time according to the status of the LSI and generating the advance notification signal. Accordingly, in any statuses of the LSI 10 (e.g., whether the LSI 10 is executing another process or the LSI is in any one of the plurality of power-saving statuses), the LSI 10 can be switched to the status capable of quickly responding to an event by a time when the event is generated. That is, according to the first embodiment, quick responsiveness can be improved.

In the semiconductor apparatus 9 according to the first embodiment, the above first status is a normal status, and the above plurality of second statuses are a plurality of power-saving statuses in which an amount of power consumed is lower than that in the normal status. That is, in the first embodiment, even when the LSI 10 is switched to the power-saving status, quick responsiveness will not be lost. Therefore, according to the first embodiment, quick responsiveness can be improved while improving power efficiency.

Note that although an example in which the advance notification signal 17 is output to both of the CPU 11 and the LSI control circuit 16 has been described, it is not limited to this. For example, the advance notification signal 17 may be output only to the CPU 11. In this case, when the status of the LSI 10 is the status B or the status C, the CPU 11 may instruct the LSI control circuit 16 to switch the status of the LSI 10 to the status A. Alternatively, for example, the advance notification signal 17 may be output only to the LSI control circuit 16. In this case, when the status of the LSI 10 is the status A, the LSI control circuit 16 may instruct the CPU 11 to switch the status of the LSI 10 to the status in which a process of an event is executed in the status A.

### Second Embodiment

Next, a second embodiment will be described. In the following description of the second embodiment, elements that are common to those in the first embodiment will be denoted by the same reference signs, and the parts of the descriptions that are common to the descriptions of the first embodiment will be omitted as appropriate.

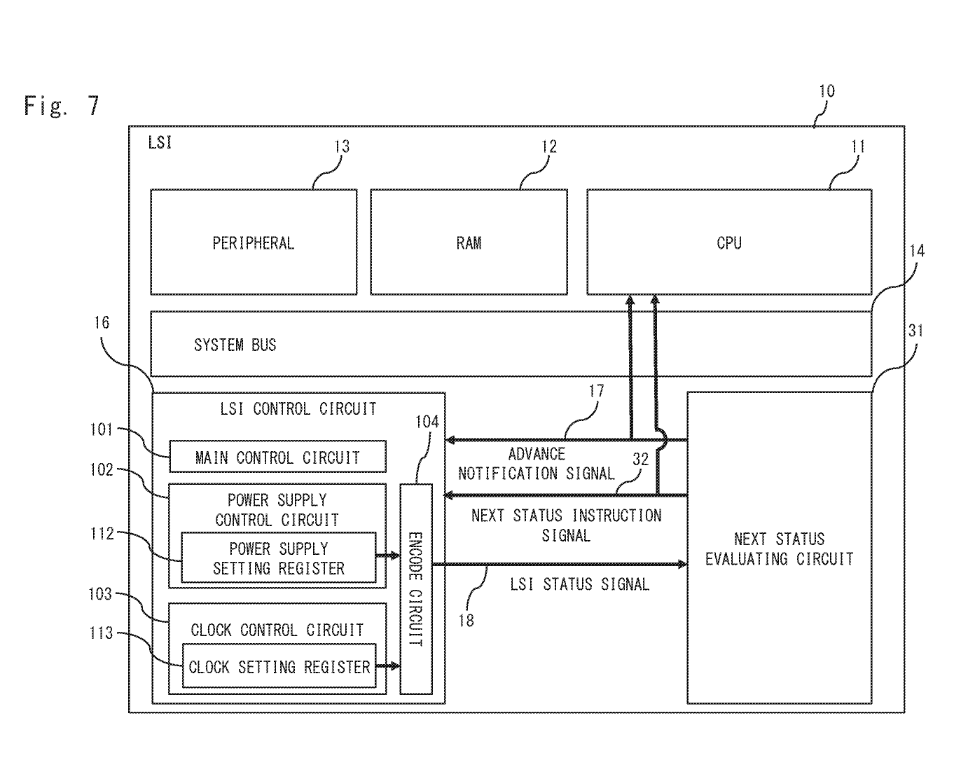

A configuration of the LSI 10 according to the second embodiment will be described with reference to FIG. 7. As shown in FIG. 7, a difference between the configuration of the LSI 10 according to the second embodiment and that of the LSI 10 according to the first embodiment is that the LSI 10 according to the second embodiment includes a next status evaluating circuit 31 in place of the advance notification generating circuit 15 in the LSI 10 according to the first embodiment.

In addition to the operations performed by the advance notification generating circuit 15, the next status evaluating circuit 31 outputs, to the LSI control circuit 16 and the CPU 11, a next status instruction signal 32 that indicates as to whether or not the status of the LSI 10 can be switched to the status in which a process other than an event is executed in the status A, to the status B, or to the status C based on the status of the LSI 10 indicated by the LSI status signal 18 output from the LSI control circuit 16. In other words, the next status instruction signal 32 indicates a candidate for the next status of the LSI 10.

Accordingly, the LSI control circuit 16 and the CPU 11 according to the second embodiment will not switch the status of the LSI 10 to a status not indicated by the next status instruction signal 32 output from the next status evaluating circuit 31 as being the status to which the LSI 10 can be switched.

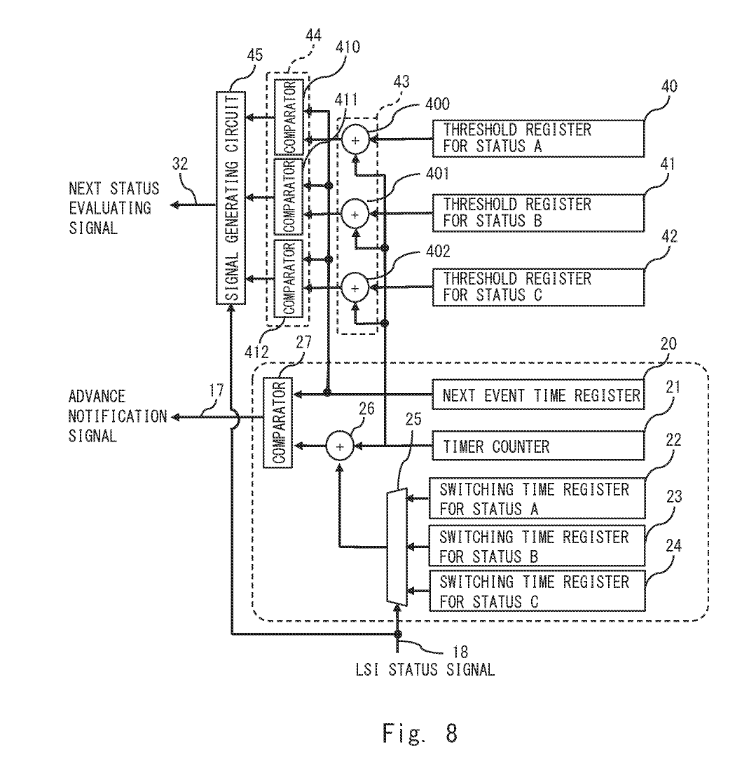

Next, a configuration of the LSI 10 according to the second embodiment will be described with reference to FIG. 8. The configuration of the LSI 10 according to the second embodiment is the same as that of the LSI 10 according to the first embodiment and further includes a threshold register for status A 40, a threshold register for status B 41, a threshold register for status C 42, an addition circuit 43, a comparison circuit 44, and a signal generating circuit 45.

The threshold register for status A 40 stores a value indicating a total time of a time required to start a process other than an event in the status A and a time required to switch the status of the LSI 10 from a status in which a process other than the event is executed to a status in which a process of the event is executed and in which the event is executable. The threshold register for status A 40 outputs a value stored therein to the addition circuit 43.

The threshold register for status B 41 stores a value indicating a total time of a time required to switch the status of the LSI 10 from a status other than the status B to the status B and a time required to switch the status of the LSI 10 from the status B to the status A so that an event can be executed. The threshold register for status B 41 outputs a value stored therein to the addition circuit 43.

The threshold register for status C 42 stores a value indicating a total time of a time required to switch the status of the LSI 10 from a status other than the status C to the status C and a time required to switch the status of the LSI 10 from the status C to the status A in which an event can be executed. The threshold register for status C 42 outputs a value stored therein to the addition circuit 43.

In a manner similar to the switching time register for status A 22, the switching time register for status B 23, and the switching time register for status C 24, the threshold register for status A 40, the threshold register for status B 41, and the threshold register for status C 42 correspond to the statuses A, B, and C, respectively, which the LSI 10 can enter. In other words, the number of the threshold register for status A 40, the threshold register for status B 41, and the threshold register for status C 42 is the same as the number of the statuses which the LSI 10 can enter. Accordingly, when the number of statuses which the LSI 10 can enter is two or four or greater, the number of the threshold registers is also the same as the number of the statuses which the LSI can enter.

The addition circuit 43 adds times indicated by values output from the respective threshold register for status A 40, the threshold register for status B 41, and the threshold register for status C 42 to a current time indicated by a value output from the timer counter 21 and then outputs values indicating times, which are results of the addition, to the comparison circuit 44. More specifically, the addition circuit 43 includes adders 400 to 402.

The adder 400 adds a value that indicates a time, which is obtained by adding the value output from the threshold register for status A 40 to the current time indicated by the value output from the timer counter 21, and then outputs the value to the comparison circuit 44. The adder 401 adds a value that indicates a time, which is obtained by adding the value output from the threshold register for status B 41 to the current time indicated by the value output from the timer counter 21, and then outputs the value to the comparison circuit 44. The adder 402 adds a value that indicates a time, which is obtained by adding the value output from the threshold register for status C 42 to the current time indicated by the value output from the timer counter 21, and then outputs the value to the comparison circuit 44.

The comparison circuit 44 compares the respective times indicated by the values output from the addition circuit 43 with a time indicated by a value output from the next event time register 20 and then outputs values indicating results of the comparison to the signal generating circuit 45. To be more specific, the comparison circuit 44 includes comparators 410 to 412.

The comparator 410 compares a time indicated by the value output from the adder 400 with the time indicated by the value output from the next event time register 20 and then outputs a value indicating a result of the comparison to the signal generating circuit 45. The comparator 411 compares a time indicated by the value output from the adder 401 with the time indicated by the value output from the next event time register 20 and then outputs a value indicating a result of the comparison to the signal generating circuit 45. The comparator 412 compares a time indicated by the value output from the adder 402 with the time indicated by the value output from the next event time register 20 and then outputs a value indicating a result of the comparison to the signal generating circuit 45.

The signal generating circuit 45 evaluates a status to which the LSI 10 can be switched based on the values output from the comparison circuit 44 and the LSI status signal 18 output from the LSI control circuit 16. The signal generating circuit 45 generates the next status instruction signal 32 that indicates the status evaluated as being the status to which the LSI 10 can be switched as a candidate for the next status of the LSI 10 and outputs the next status instruction signal 32 to the LSI control circuit 16. To be more specific, the signal generating circuit 45 evaluates as to whether or not the LSI 10 can be switched to the status in which a process other than an event is executed in the status A, to the status B, and to the status C according to the following conditions.

(1) When (a time indicated by a value from the next event time register 20>a value from the adder 400) is satisfied:

It is possible to switch the status to the status in which a process other than an event is executed in the status A. That is, the LSI 10 is maintained in the status A or the status is switched from the status B or C to the status A, and then a process other than the event can be executed.

(2) When (a time indicated by a value from the next event time register 20≦a value from the adder 400) is satisfied:

It is not possible to switch the status to the status in which a process other than an event is executed in the status A (when execution of a process other than the event is already started, execution of the process other than the event can be continued).

Note that as a time taken to end the process other than the event is shorter than a time to switch the status of the LSI 10, this condition will not be satisfied in the status B or C. That is, when this condition is satisfied, the status is already switched to the status A by the advance notification signal 17.

(3) When (a time indicated by a value from the next event time register 20>a value from the adder 401) is satisfied:

It is possible to switch the status to the status B.

That is, the LSI 10 can be maintained in the status B, or the status can be switched from the status A or C to the status B.

(4) When (a time indicated by a value from the next event time register 20≦a value from the adder 401) is satisfied:

It is not possible to switch the status to the status B. That is, the status cannot be switched from the status A or the status C to the status B (when the LSI 10 is already in the status B, the LSI 10 can be maintained in the status B).

(5) When (a time indicated by a value from the next event time register 20>a value from the adder 402) is satisfied:

It is possible to switch the status to the status C. That is, the LSI 10 can be maintained in the status C or the status can be switched from the status A or B to the status C.

(6) When (a time indicated by a value from the next event time register 20≦a value from the adder 402) is satisfied:

It is not possible to switch the status to the status C. That is, it is not possible to switch the status from the status A or B to the status C (when the LSI 10 is already in the status C, the LSI 10 can be maintained in the status C).

A specific example will be described below.

For example, suppose:

A time of the threshold register for status A 40=10,

A time of the threshold register for status B 41=30,

A time of the threshold register for status C 42=50,

The timer counter 21=100, and

The next event time register 20=180.

In this case, it will be as follows.

180 (the next event time register 20)

>100 (the timer counter 21)+10 (the threshold register for status A 40)

180 (the next event time register 20)

>100 (the timer counter 21)+30 (the threshold register for status B 41)

180 (the next event time register 20)

>100 (the timer counter 21)+50 (the threshold register for status C 42)

Accordingly, for all the statuses A, B, and C, times obtained by adding the time of the timer counter 21 to the respective times of the threshold registers (the threshold register for status A 40, the threshold register for status B 41, and the threshold register for status C 42) are before the time of the next event time register 20. It is thus possible to switch the status to the status in which a process of an event is executed in the status A so that the event can be executed by a time when the event is generated even when the LSI 10 is executing a process other than the event in the status A or the status is switched to the status B or C. In such a case, the signal generating circuit 45 outputs, to both of the CPU 11 and the LSI control circuit 16, the next status instruction signal 32 indicating that the status of the LSI 10 can be switched to the status in which a process other than an event is executed in the status A, to the status B, or to the status C.

In the above condition, when the time of the next event time register 20=140, as for the status C, a time obtained by adding the time of the threshold register for status C 42 to the time of the timer counter 21 will become a time at or after the time of the next event time register 20. Thus, when the status is switched from the status A or B to the status C, the status cannot be switched from the status C to A and a preparation for processing the event cannot be completed until when the event is generated. Therefore, in this case, the signal generating circuit 45 outputs, to both of the CPU 11 and the LSI control circuit 16, the next status instruction signal 32 indicating that the status can be switched to the status in which a process other than the event can be executed in the status A and to the status B but not to the status C.

On the other hand, even in such a case, when the LSI 10 is in the status C, the LSI 10 can be maintained in the status C. This is because when the status is switched from the status A or B to the status C, the LSI 10 will not be ready to execute the process of the event by a time when the event is generated, whereas when the status is already in the status C, the LSI 10 can be switched to the status A in response to the advance notification signal 17 and can be ready to execute the process of the event by the time when the event is generated. Accordingly, even when the status cannot be switched to the status C, the signal generating circuit 45 outputs, to both of the CPU 11 and the LSI control circuit 16, the next status instruction signal 32 indicating that the status can be switched to the status in which a process other than an event is executed in the status A, the status B, or the status C if the LSI status signal 10 indicates the status C. Accordingly, the LSI control circuit 16 will not determine that it is necessary to switch the status from the status C to the status A or B, and thus the LSI 10 can be maintained in the status C.

The CPU 11 and the LSI control circuit 16 evaluate as to whether or not the LSI 10 can be switched to the status in which a process other than an event is executed in the status A, to the status B, and to the status C according to the next status instruction signal 32 output from the next status instruction signal 32. More specifically, when the next status instruction signal 32 indicates that the status cannot be switched to the status in which a process other than the event is executed in the status A, the CPU 11 prevents the status from being switched to the status in which a process other than the event is executed in the status A. When the next status instruction signal 32 indicates that the status cannot be switched to the status B, the LSI control circuit 16 prevents the status from being switched to the status B. Moreover, when the next status instruction signal 32 indicates that the status cannot be switched to the status C, the LSI control circuit 16 prevents the status from being switched to the status C.

In the first embodiment, as the switching of the status of the LSI 10 is performed independently from transmitting the advance notification of the event, the status of the LSI 10 may be switched to a status that cannot be returned to the status in which an event can be executed by a time when the event is generated. In this respect, in the second embodiment, the evaluating circuit that evaluates a candidate for the next status of the LSI is further included in addition to the circuit that generates and outputs an advance notification.

More specifically in the second embodiment, the threshold storage circuits (i.e., the threshold register for status A 40, the threshold register for status B 41, and the threshold register for status C 42) and the evaluating circuits (i.e., other circuits 43 to 45 in the next status evaluating circuit 31) are further included in addition to the configuration of the first embodiment.

The threshold storage circuits store, for each of the plurality of second statuses, a value indicating a total time of a time required to switch the status to the second status and a switching time required to switch the status from this second status to the first status so that an event can be executed. When a time, which is obtained by adding the time indicated by the threshold corresponding to the second status to a current time, is a time at or after a time when the event is generated, the evaluating circuit outputs, to the control circuit, a next status instruction signal that indicates a candidate for the next status of the semiconductor apparatus, which excludes the second status corresponding to the threshold.

Since the candidate for the next status indicates only the status that can be switched to the status in which a process of an event can be executed before the event is generated, a possible problem in the first embodiment can be avoided. Thus, according to the second embodiment, quick responsiveness can be further improved.

In addition, in the second exemplary embodiment, even when the time, which is obtained by adding the time indicated by the threshold corresponding to the second status to a current time, is a time at or after a time when the event is generated, if the status of the semiconductor apparatus indicated by the status signal transmitted from the control circuit is the second status corresponding to the threshold, the evaluating circuit will not exclude the second status corresponding to the threshold from the candidate for the next status of the semiconductor apparatus. This prevents unnecessary switching of the status.

Note that although an example in which the next status instruction signal 32 is output to both of the CPU 11 and the LSI control circuit 16, it is not limited to this. For example, the next status instruction signal 32 may be output only to the CPU 11. In this case, if the next status instruction signal 32 indicates that the status cannot be switched to at least one of the status B and the status C, the CPU 11 may notify the LSI control circuit 16 to that effect. For example, the next status instruction signal 32 may be output only to the LSI control circuit 16. In this case, if the next status instruction signal 32 indicates that the status cannot be switched to the status in which a process other than an event is executed in the status A, the LSI control circuit 16 may notify the CPU 11 to that effect.

Although the invention carried out by the present inventor has been described in detail according to the embodiments, it is obvious that the present invention is not limited to the above embodiments, and various modifications can be made without departing from the scope of the invention.

For example, in the above embodiment, although an example in which the numbers of the switching time registers and the threshold registers are the same as the number of statuses which the LSI 10 can enter has been described, it is not limited to this. When there are two or more statuses in which the switching time is the same and the threshold is the same, a common switching time register and a common threshold register may be used, respectively, in the two or more statuses.

Further, in the above embodiments, although an example in which both of the power supply status and the clock supply status of the LSI 10 are controlled has been described, only one of these statuses may be controlled. That is, the LSI 10 may be configured to include only one of the power supply control circuit 102 and the clock control circuit 103. In this case, the encode circuit 104 generates the LSI status signal 18 based on one of the power supply setting value and the clock setting value.

Furthermore, in the second embodiment, although an example in which the inequality sign in the conditions (1), (3), and (5) is “>”, and the inequality sign in the conditions (2), (4), and (6) is “≦” has been described, it is not limited to this. For example, the inequality sign in the conditions (1), (3), and (5) may be “≧”, and the inequality sign in the conditions (2), (4), and (6) may be “<”. However, in such a case, after the status is switched, the status may be immediately returned from the switched status to the status in which a process of an event is executed in the status A (when a time indicated by a value from the next event time register 20=a value from the adder). It is thus preferable to have the inequality signs in the conditions (1) to (6) as those described in the second embodiment.

The first and second embodiments can be combined as desirable by one of ordinary skill in the art.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A semiconductor apparatus being configured to operate in one of a first status in which a generated event is processed and a plurality of second statuses in which the event is not processed, the semiconductor apparatus comprising:
a control circuit configured to control a status of the semiconductor apparatus and output a status signal, the status signal indicating the status of the semiconductor apparatus;
a switching time storage circuit configured to store, for each of the plurality of second statuses, a switching time required to switch the status of the semiconductor apparatus from the second status to the first status so that the event can be processed; and
a notification circuit configured to select, when the status of the semiconductor apparatus is one of the plurality of second statuses, from the switching time storage circuit, the switching time corresponding to the one of the plurality of second statuses indicated by the status signal output from the control circuit and output, to the control circuit, a notification signal for previously notifying the control circuit of generation of the event when a time, which is obtained by adding the selected switching time to a current time, reaches a time when the event is generated, wherein
the control circuit is configured to switch the status of the semiconductor apparatus from the second status to the first status in response to the notification signal from the notification circuit.

2. The semiconductor apparatus according to claim 1, wherein
the first status is a normal status, and
the plurality of second statuses include a plurality of power-saving statuses in which an amount of power consumed is lower than that in the normal status.

3. The semiconductor apparatus according to claim 2, wherein
the first status is a status in which a process of the event is executed in the normal status, and
the second status includes a status in which a process other than the event is executed in the normal status.

4. The semiconductor apparatus according to claim 2, wherein the control circuit comprises:
a power supply control circuit including a power supply setting register and configured to control a power supply status of the semiconductor apparatus so that the semiconductor apparatus will be in the power supply status according to a setting value set to the power supply setting register;
a main control circuit configured to set the setting value to the power supply setting register in the control on the status of the semiconductor apparatus; and
a signal generating circuit configured to set the status signal indicating the status of the semiconductor apparatus based on the setting value stored in the power supply setting register.

5. The semiconductor apparatus according to claim 2, wherein the control circuit comprises:
a clock control circuit including a clock setting register and configured to control a clock supply status of the semiconductor apparatus so that the semiconductor apparatus will be in the clock supply status according to a setting value set to the clock setting register;
a main control circuit configured to set the setting value to the clock setting register in the control on the status of the semiconductor apparatus; and
a signal generating circuit configured to generate the status signal indicating the status of the semiconductor apparatus based on the setting value stored in the clock setting register.

6. The semiconductor apparatus according to claim 2, wherein
the plurality of power-saving statuses include a first power-saving status and a second power-saving status in which an amount of power consumed is lower than that in the first power-saving status and in which the switching time is longer than that in the first power-saving status, and
the control circuit is configured to be capable of switching the status of the semiconductor apparatus from the first power-saving status to the second power-saving status.

7. The semiconductor apparatus according to claim 1, further comprising:
a threshold storage circuit configured to store a threshold indicating a total time for each of the plurality of second statuses, the total time being a total of a time required to switch the status of the semiconductor apparatus to the second status and the switching time required to switch the status of the semiconductor apparatus from the second status to the first status so that the event can be executed; and
an evaluating circuit configured to output a next status instruction signal indicating a candidate for a next status of the semiconductor apparatus to the control circuit, the evaluating circuit being configured to exclude, when a time, which is obtained by adding the threshold corresponding to the second status to a current time, is at or after the time when the event is generated, the second status corresponding to the threshold from the candidate, wherein the control circuit is configured to prevent the status of the semiconductor apparatus from being switched to the second status that is excluded from the candidate indicated by the next status instruction signal output from the evaluating circuit.

8. The semiconductor apparatus according to claim 7, wherein
the control circuit is configured to transmit the status signal also to the evaluating circuit, and
even when the time, which is obtained by adding the threshold corresponding to the second status to the current time, is at or after the time when the event is generated, if the status of the semiconductor apparatus indicated by the status signal transmitted from the control signal is the second status corresponding to the threshold, the evaluating circuit is configured not to exclude the second status corresponding to the threshold from the candidate for the next status of the semiconductor apparatus.

9. The semiconductor apparatus according to claim 1, wherein
the switching time storage circuit includes a plurality of switching time registers,
the plurality of switching time registers is configured to store switching times of the plurality of second statuses, respectively,
the semiconductor apparatus further comprises:
a next event time register configured to store the time when the event is generated;
a multiplexer configured to select the switching time stored in one of the plurality of switching time registers corresponding to the second status indicated by the status signal;
an adder configured to calculate a time by adding the switching time selected by the multiplexer to a current time counted by the timer counter; and
a comparator configured to output the notification signal when the time calculated by the adder reaches the time stored in the next event time register.

10. The semiconductor apparatus according to claim 1, wherein
the semiconductor apparatus is included in a slave in an industrial network system, and
reception of an event transmitted from a master in the industrial network system is treated as the generation of the event.

11. A method for controlling a status of a semiconductor apparatus being configured to operate in one of a first status in which a generated event is processed and a plurality of second statuses in which the event is not processed, the method comprising steps of:
receiving a status signal from a control circuit configured to control the status of the semiconductor apparatus, the status signal indicating a status of the semiconductor apparatus;
selecting, when the status of the semiconductor apparatus is one of the plurality of second statuses, from a switching time storage circuit, a switching time corresponding to the one of the plurality of second statuses indicated by the status signal output from the control circuit, the switching time storage circuit being configured to store, for each of the plurality of second statuses, the switching time required to switch the status of the semiconductor apparatus from the second status to the first status so that the event can be processed;
outputting, to the control circuit, a notification signal for previously notifying the control circuit of generation of the event when a time, which is obtained by adding the selected switching time to a current time, reaches a time when the event is generated in order for the control circuit to switch the status of the semiconductor apparatus from the second status to the first status.
